(19) United States
(12) Patent Application Publication
(10) Pub. No.: US 2026/0099680 A1
(43) Pub. Date: Apr. 9, 2026

(54) ALTERNATIVE AND ASYNCHRONOUS DIGITAL CONTENT GENERATION USING MACHINE LEARNING

(71) Applicant: Adobe Inc., San Jose, CA (US)

(72) Inventors: Benjamin Paul Olsem, Mound, MN (US); Tom M. Nguyen, San Diego, CA (US)

(73) Assignee: Adobe Inc., San Jose, CA (US)

(21) Appl. No.: 18/910,902

(22) Filed: Oct. 9, 2024

(51) Int. Cl. G06F 40/40; G06T 11/60

(52) U.S. Cl. CPC G06F 40/40; G06T 11/60; G06T 2200/24

(57) ABSTRACT

Alternative and asynchronous digital content generation techniques using machine learning are described. In one or more examples, a single input is received specifying one or more characteristics of digital content to be generated using generative artificial intelligence (AI) as implemented using one or more machine-learning models. A processing device detects that the single input specifies a plurality of alternatives to be used in the generation of the digital content. A plurality of prompt alternatives are then generated, each prompt alternative corresponding to a respective alternative of the plurality of alternatives. A plurality of digital content is received that is generated by the one or more machine-learning models using the generative artificial intelligence responsive to processing of the plurality of prompt alternatives. The plurality of digital content is presented for display in a user interface.

### BACKGROUND

Generative artificial intelligence, i.e., “generative AI,” refers to techniques implemented using one or more machine-learning models to generate digital content such as text, images, audio, video, executable code, and so forth. Conventional techniques used to access generative AI, however, are cumbersome and limiting due to a variety of technical challenges.

These technical challenges encountered in real world scenarios cause a variety of complications. Examples of complications include a suboptimal user experience, inefficient use of computational resources used to implement the generative artificial intelligence, may result in inaccuracies caused by inaccuracies in manual entry of characteristics specified for generating the digital content, and so forth.

### SUMMARY

Alternative and asynchronous digital content generation techniques using machine learning are described. In one or more initial examples, a generative artificial intelligence (AI) system is configured to detect a plurality of alternatives referenced in a single input that specifies characteristics to be used as a basis to generate digital content. In response, the generative AI system generates prompt alternatives, automatically and without user intervention, for each of the alternatives detected in the single input.

In one or more additional examples, a generative AI system supports asynchronous generation of digital content. The generative AI system, for instance, supports a change to an initial prompt before digital content is received based on the initial prompt, e.g., to support edits, specify alternatives, and so forth. In response, the generative AI system forms an additional prompt that incorporates the edits, which is then also output in a user interface along with the initial prompt in one or more instances. A variety of other examples are also contemplated.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRA WINGS

The detailed description is described with reference to the accompanying figures. Entities represented in the figures are indicative of one or more entities and thus reference is made interchangeably to single or plural forms of the entities in the discussion.

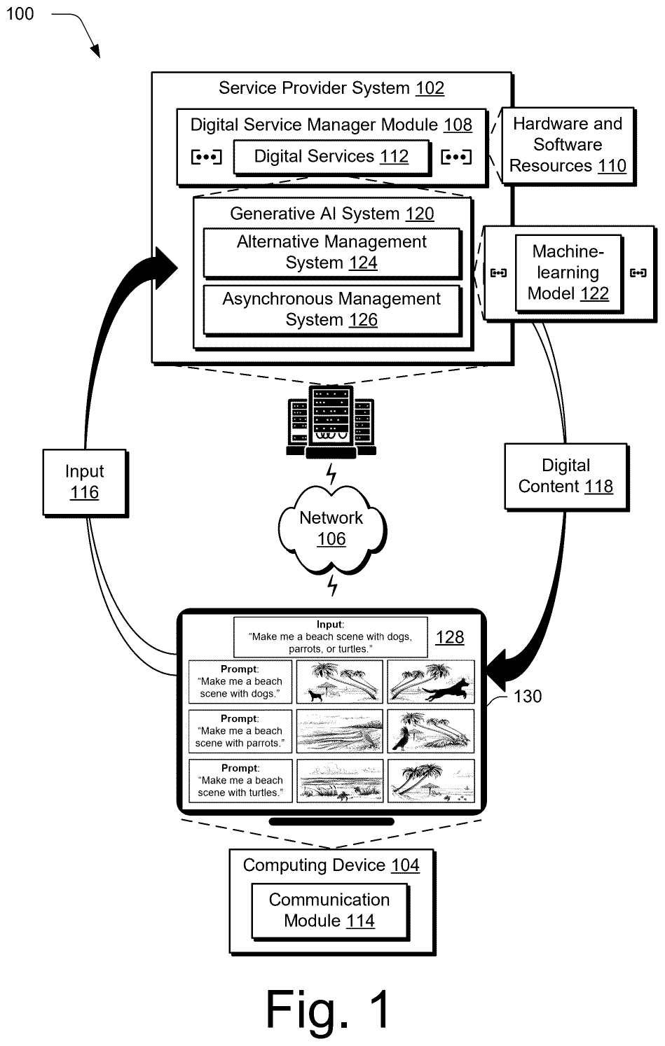

FIG. 1 is an illustration of an environment in an example implementation that is operable to employ alternative and asynchronous digital content generation techniques using machine learning as described herein.

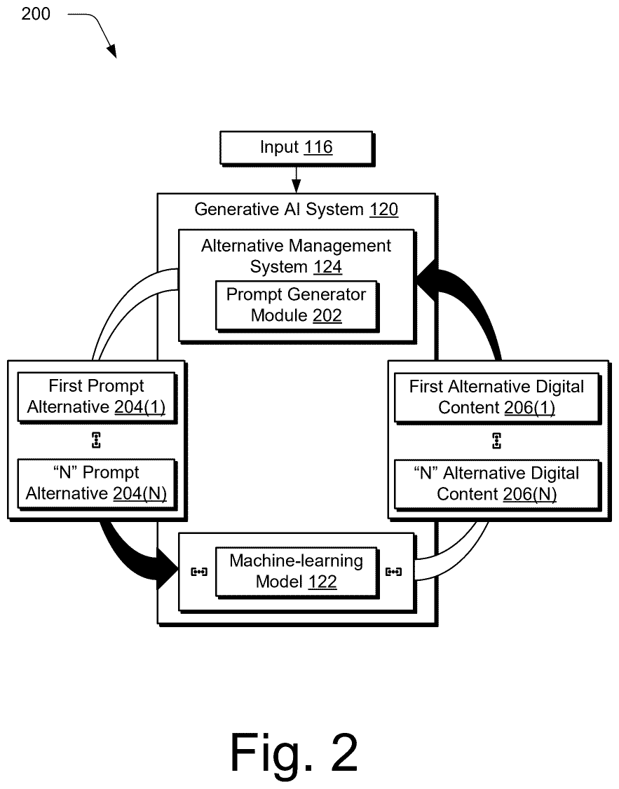

FIG. 2 depicts a system in an example implementation showing operation of an alternative management system of a generative artificial intelligence (AI) system of FIG. 1 in greater detail.

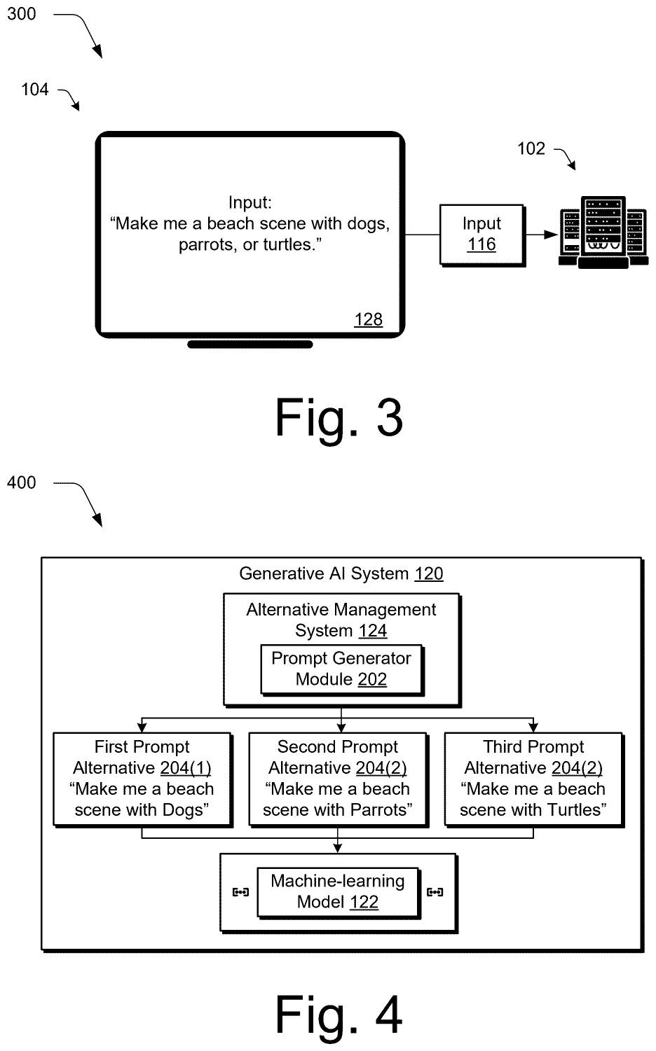

FIG. 3 depicts a system in an example implementation showing reception of an input to initiate digital content alternative generation.

FIG. 4 depicts a system in an example implementation of prompt alternative formation by a prompt generator module of the alternative management system of FIG. 2 in greater detail.

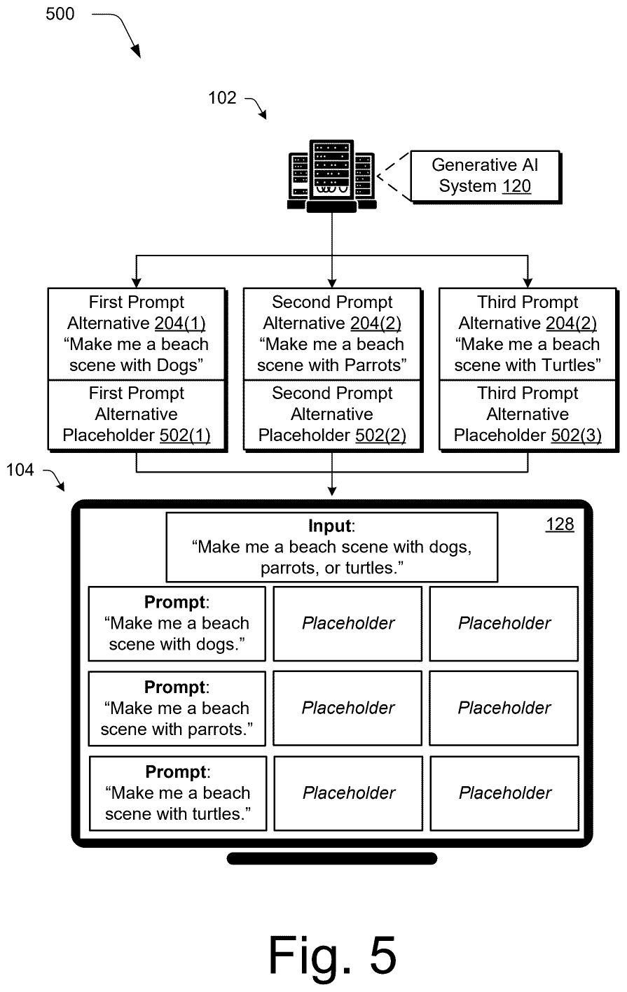

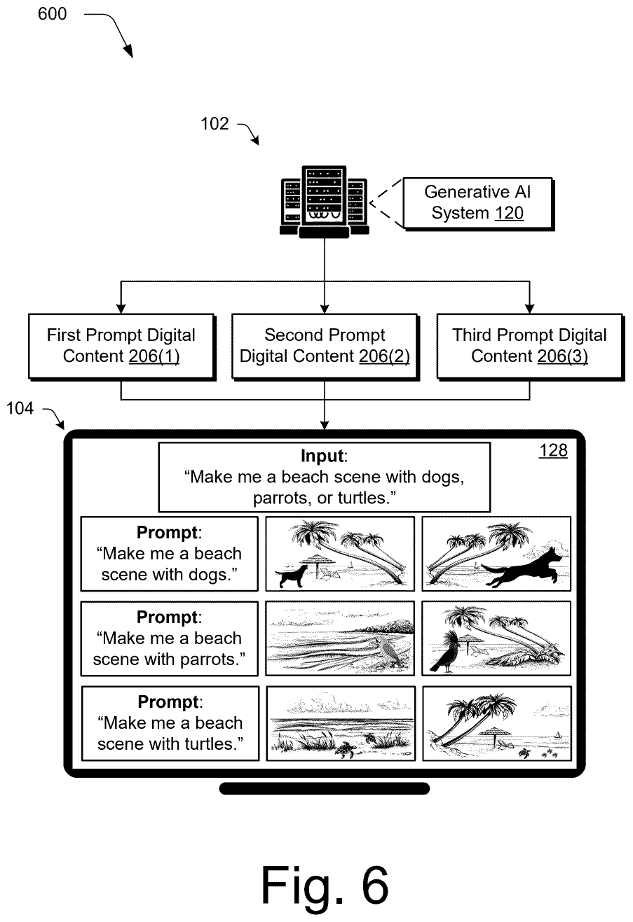

FIG. 5 depicts a system in an example implementation of presenting prompt alternatives and placeholders by the generative AI system of the service provider system for inclusion in a user interface of the computing device.

FIG. 6 depicts a system in an example implementation of presenting prompt alternatives and digital content generated by the generative AI system of FIG. 2 for respective prompt alternatives for inclusion in a user interface of the computing device.

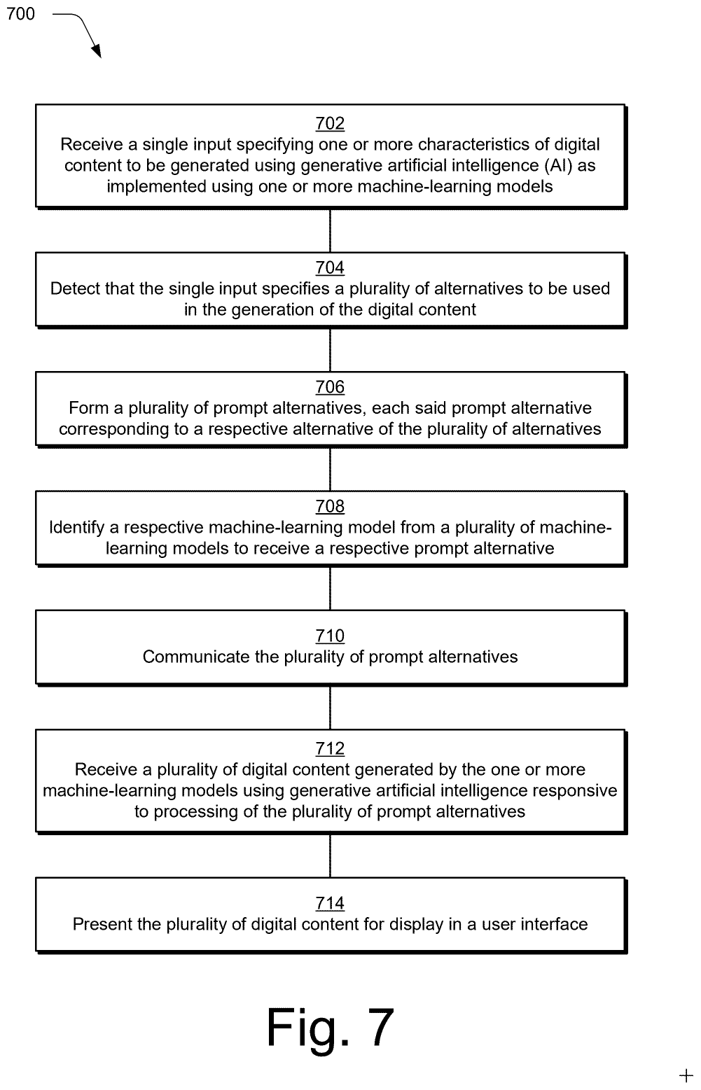

FIG. 7 is a flow diagram depicting an algorithm as a step-by-step procedure in an example implementation of operations performable for accomplishing a result of alternative digital content generation through formation of a plurality of prompt alternatives for alternatives detected in a single input.

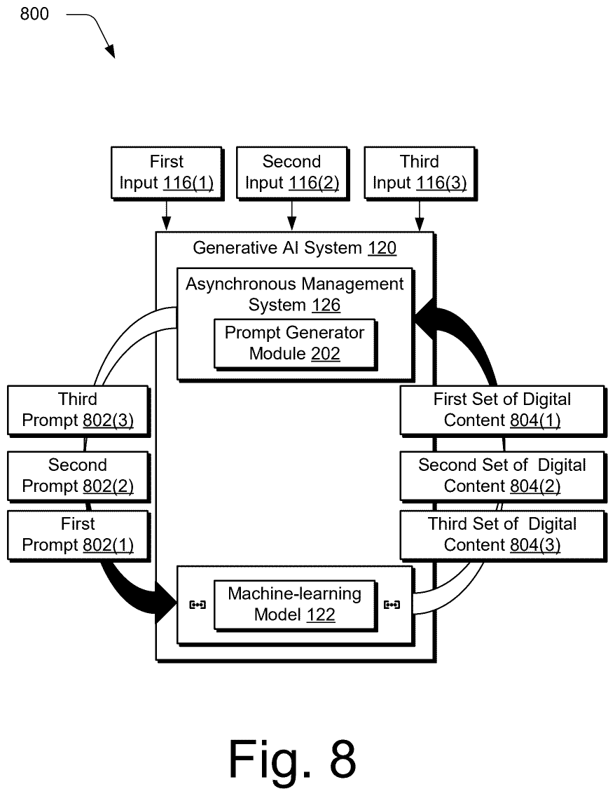

FIG. 8 depicts a system in an example implementation showing operation of the asynchronous management system of the generative AI system of FIG. 1 in greater detail.

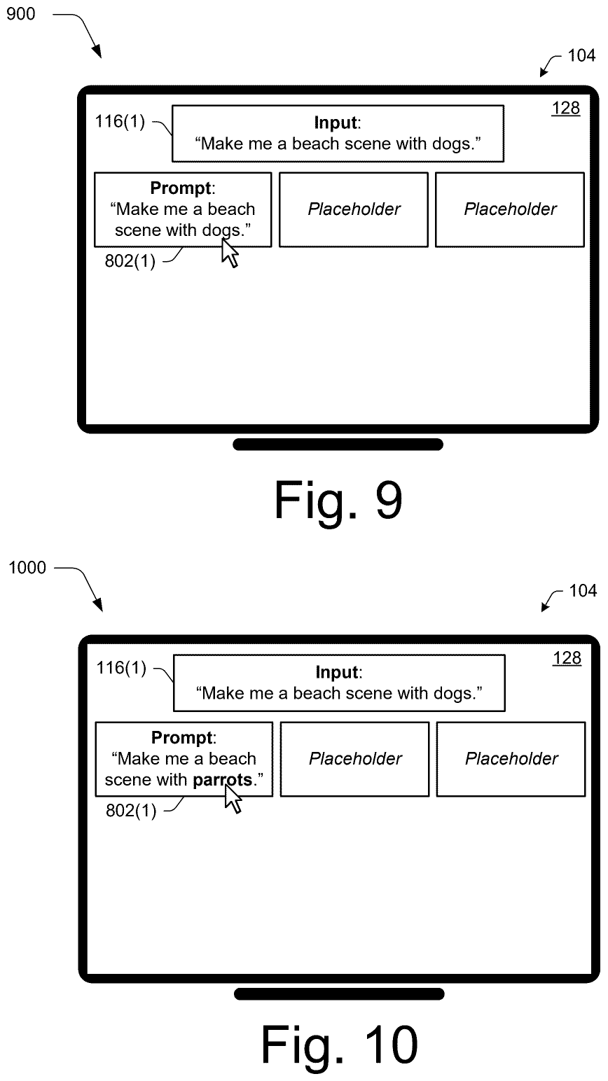

FIG. 9 depicts a system in an example implementation showing creation of a first input via interaction with a user interface at a computing device.

FIG. 10 depicts a system in an example implementation showing an edit to a first prompt of FIG. 9 via interaction with a user interface at a computing device.

FIG. 11 depicts a system in an example implementation showing presentation of prompts that are generated based on the edit to the first prompt of FIG. 10 via interaction with a user interface at a computing device.

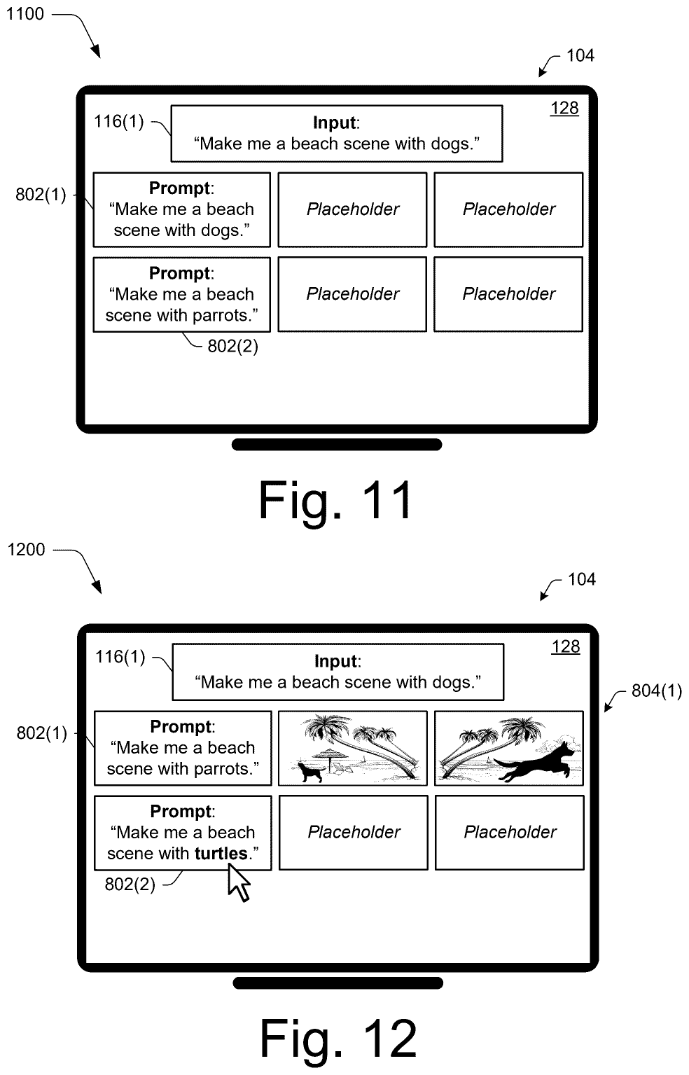

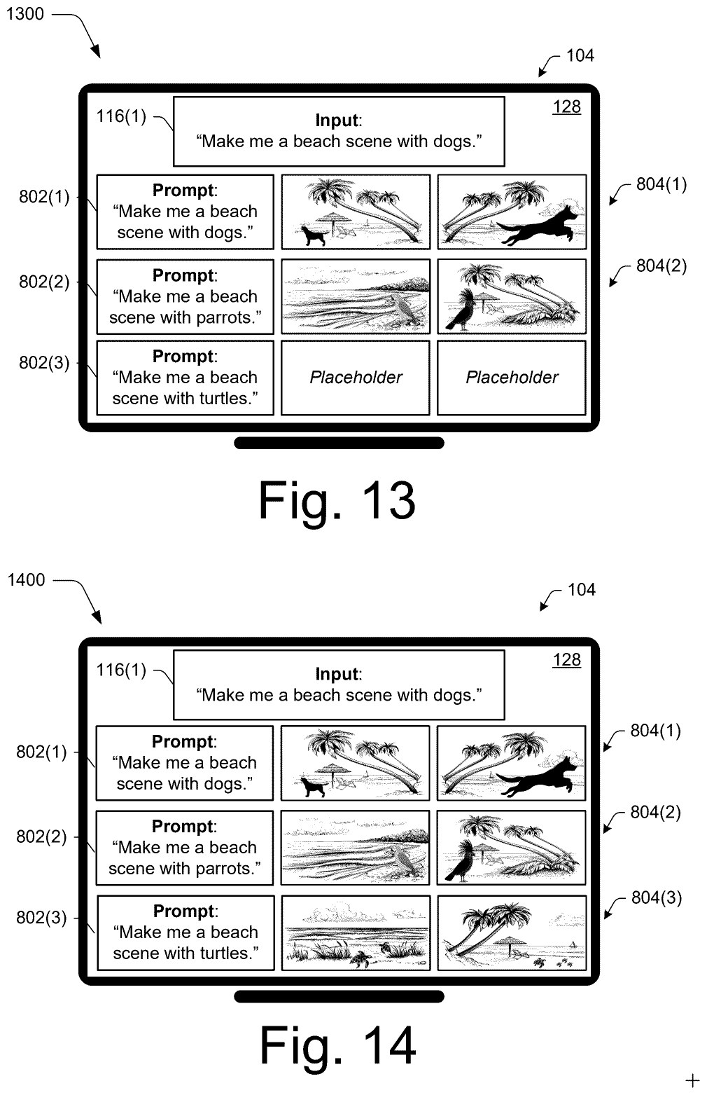

FIG. 12 depicts an example implementation of an edit to text of a second prompt of FIG. 11.

FIG. 13 depicts an example implementation showing presentation of prompts that are generated based on the edit to the second prompt of FIG. 12 via interaction with a user interface at a computing device.

FIG. 14 depicts an example implementation showing presentation of the first set of digital content as associated with the first prompt, the second set of digital content as associated with the second prompt, and the third set of digital content as associated with the third prompt.

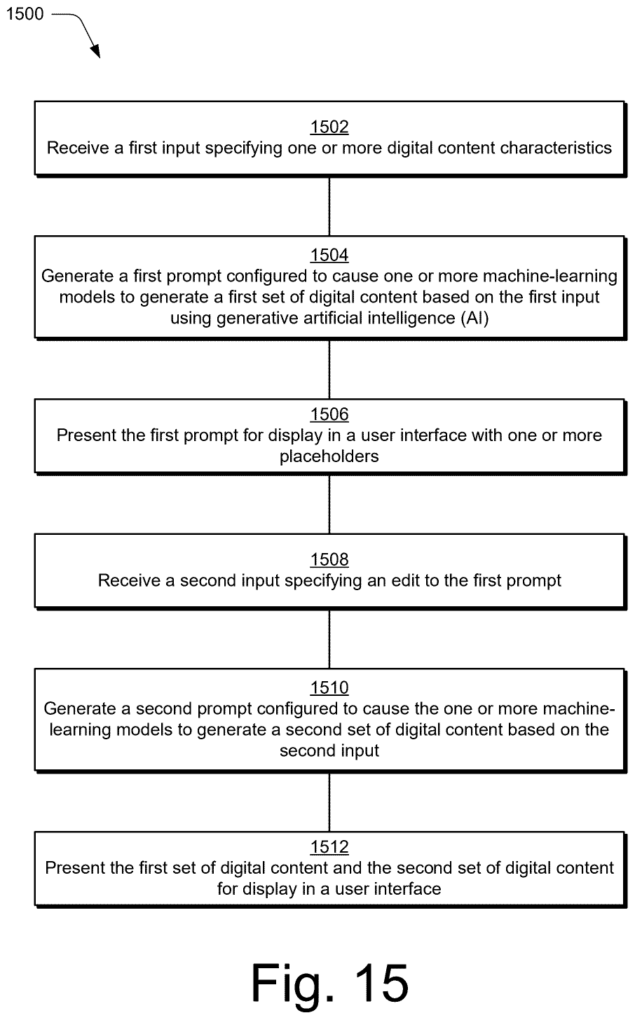

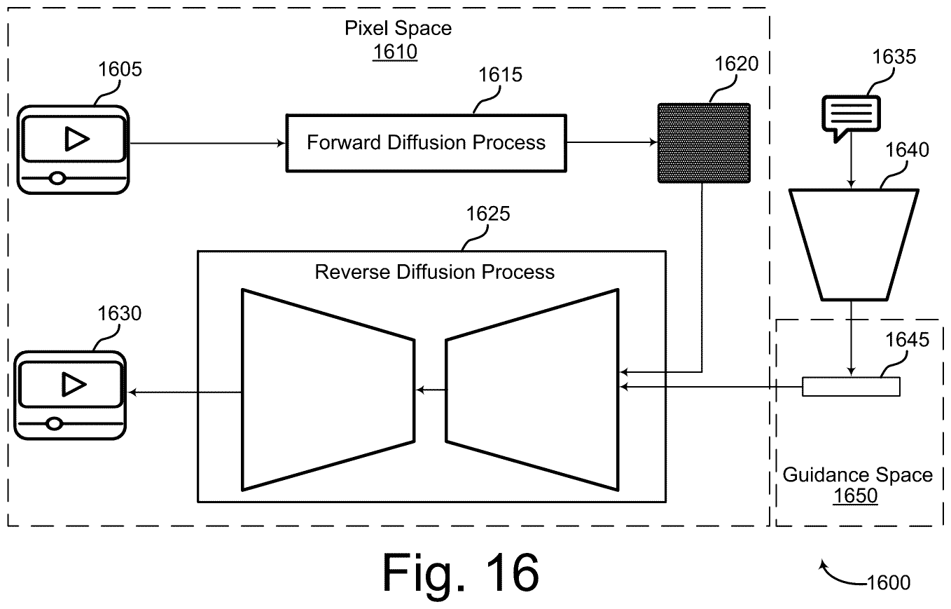

FIG. 15 is a flow diagram depicting an algorithm as a step-by-step procedure in an example implementation of operations performable for accomplishing a result of asynchronous digital content generation.

FIG. 16 shows an example of a guided diffusion model according to aspects of the present disclosure.

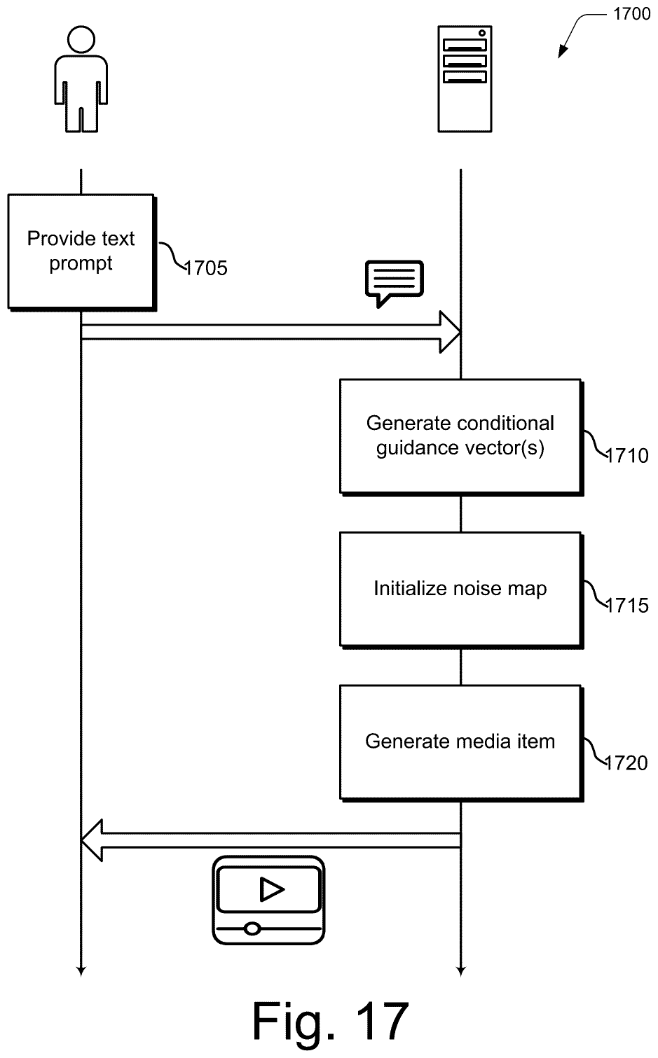

FIG. 17 shows an example of a technique for conditional media generation according to aspects of the present disclosure.

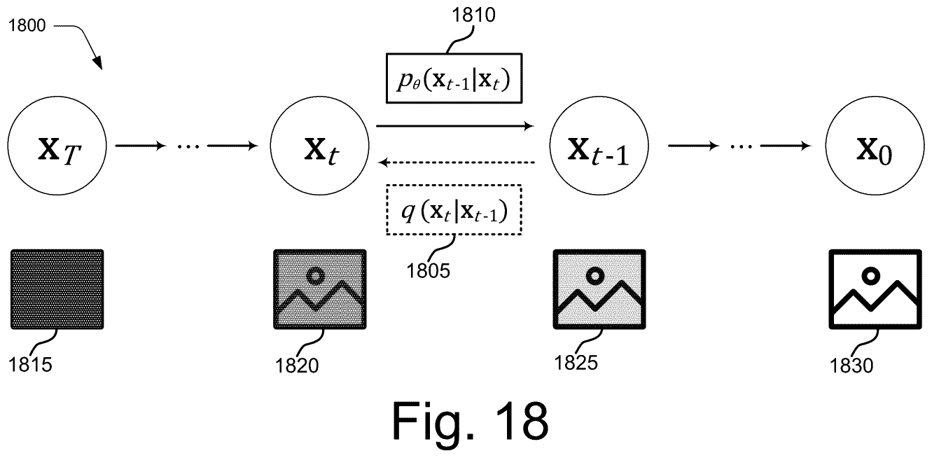

FIG. 18 shows a diffusion process according to aspects of the present disclosure.

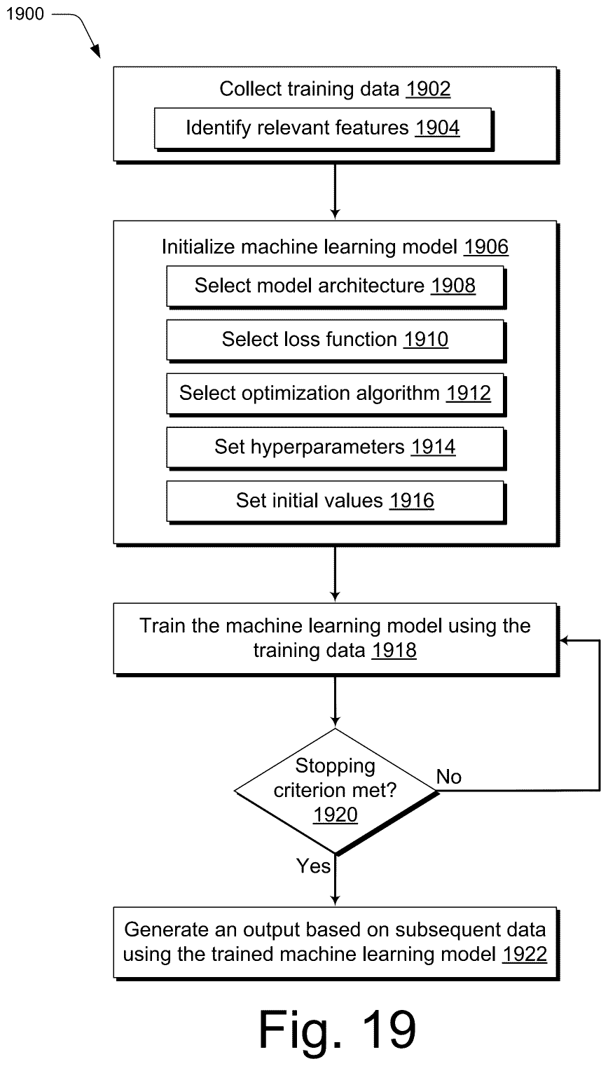

FIG. 19 is a flow diagram depicting an algorithm as a step-by-step procedure in an example implementation of operations performable for training a machine-learning model.

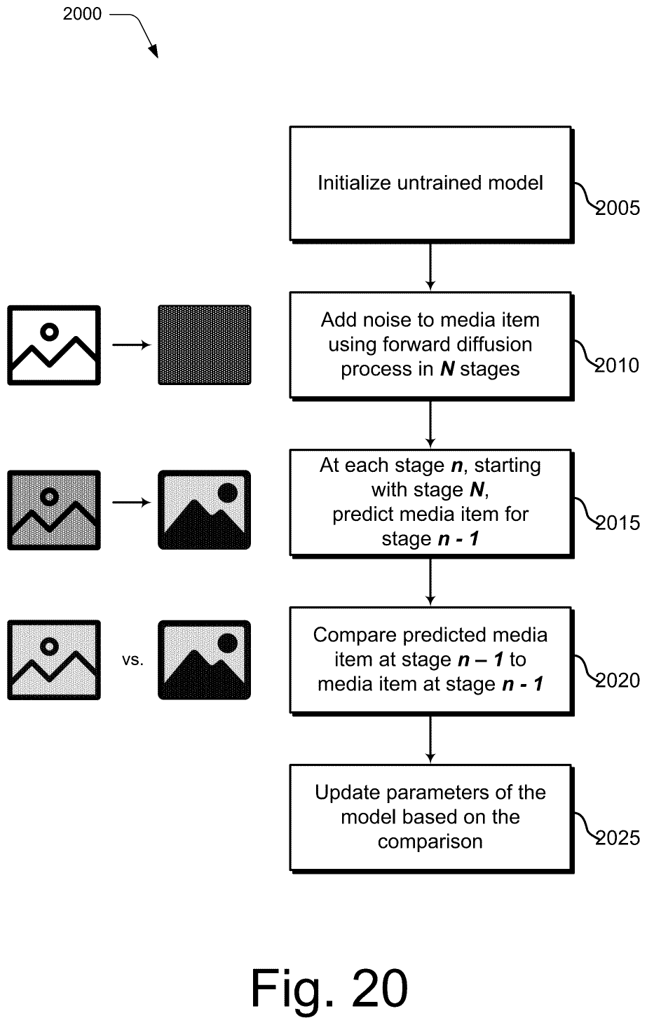

FIG. 20 shows an example of a technique for training a diffusion model according to aspects of the present disclosure.

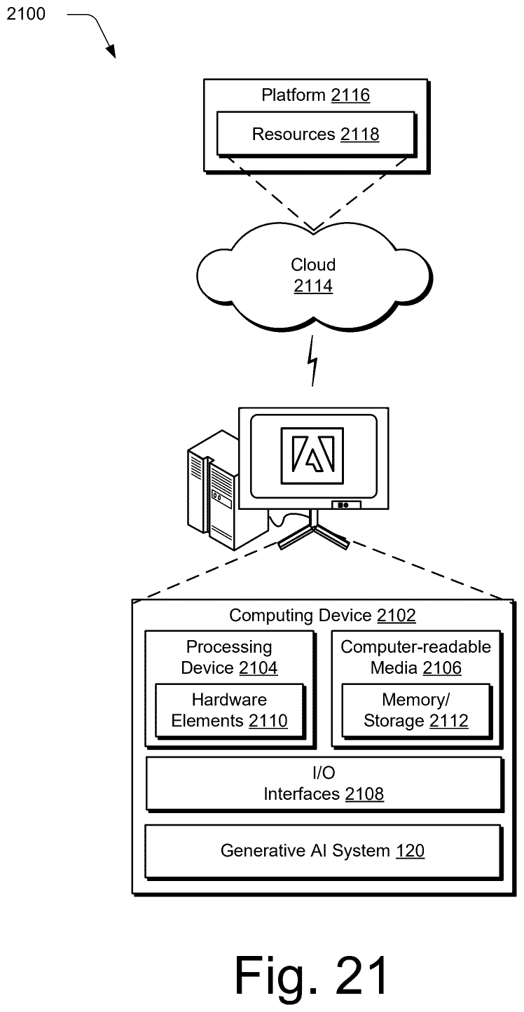

FIG. 21 an example system including various components of an example device that can be implemented as any type of computing device as described and/or utilize with reference to the previous figures to implement embodiments of the techniques described herein.

### DETAILED DESCRIPTION

### Overview

Generative artificial intelligence as implemented using one or more machine-learning models is configurable to generate a wide range of digital content, examples of which include text, images, audio, video, spreadsheets, executable code, and so forth. Conventional techniques used to access this functionality, however, are cumbersome as involving synchronous generation and independent entry of variations.

In an initial conventional example, conventional techniques forced users to manually provide independent inputs for each digital content alternative, e.g., “a red sportscar,” “a yellow sportscar,” and “a green sportscar.” Therefore, conventional techniques have an increased likelihood of user error in manually entering each alternative separately, increased delay due to the manual entry, as well as increased computational resource consumption.

Accordingly, in one or more examples a generative artificial intelligence (AI) system is configured to detect a plurality of alternatives included in a single input that specifies characteristics to be used as a basis to generate digital content. Continuing with the previous example, the generative AI system receives a single input specifying “a red, yellow, or green sportscar.” In response, the generative AI system generates a plurality of prompt alternatives, automatically and without user intervention, for each of the alternatives detected in the single input, e.g., “a red sportscar,” “a yellow sportscar,” and “a green sportscar” for the alternatives “red,” “yellow,” and “green.”

The prompt alternatives are then communicated by the generative AI system for receipt by one or more machine learning models. The generative AI system, in one or more instances, also presents the prompt alternatives for display in a user interface along with corresponding placeholders. The placeholders are then replaced with digital content that corresponds to the respective prompt alternatives as the digital content is received from the one or more machine-learning models. As a result, display of the prompt alternatives inform a user as to which alternatives are detected and used as a basis for digital content generation, further discussion of which may be found in relation to FIGS. 2-7.

In another conventional example, an input is provided to generate a digital image, e.g., “a red sportscar.” Text from the input is then processed by one or more machine-learning models to generate corresponding digital content. Suppose, however, that there is a typographical error in the input or other inaccuracy, e.g., “a read sportscar” or that the user actually desired something different such as a “a yellow sportscar.” In conventional techniques, a user is typically forced to wait until the input is processed to then manually provide a new input with a desired correction, which is often reentered in its entirety. Accordingly, these technical challenges reduce user efficiency, result in inefficient use of computational resources, and are frustrating.

Accordingly, in one or more examples asynchronous digital content generation is supported using machine learning. In contrast to the above conventional scenario, suppose an input is mistakenly input to generate “a read sportscar.” A generative AI system receives the input and displays a prompt generated based on the input for display in a user interface, which may include one or more placeholders for digital content to be generated. A user, when viewing the prompt, notices the error as “a read sportscar” and then makes an edit directly to the prompt by changing “read” to “red.”

In response, the generative AI system generates another prompt which is presented for display in the user interface along with corresponding placeholders. This presentation may be performed along with the first prompt which is returned to its original form. As digital content is received that is generated for the respective prompts, the placeholders are then replaced with the digital content in the user interface. Other examples are also contemplated in which processing of the initial prompt is cancelled and replaced by the additional prompt. As a result, the user is provided with unrestricted access as part of an intuitive workflow, further discussion of which may be found in relation to FIGS. 8-15.

### Term Examples

A “machine-learning model” refers to a computer representation that can be tuned (e.g., trained and retrained) based on inputs to approximate unknown functions. In particular, the term machine-learning model can include a model that utilizes algorithms to learn from, and make predictions on, known data by analyzing training data to learn and relearn to generate outputs that reflect patterns and attributes of the training data. Examples of machine-learning models include neural networks, convolutional neural networks (CNNs), long short-term memory (LSTM) neural networks, decision trees, and so forth.

A “large language model” (LLM) is a type of machine-learning model that is designed to understand, generate, and interact with human language inputs at a large scale. These machine-learning models are trained on vast amounts of text data using deep learning techniques (e.g., neural networks) to learn patterns, nuances, and the structure of language. The use of the term “large” refers to both the size of the training data and also to the complexity and scale of the neural networks, which may include billions or even trillions of parameters.

Large language models are configurable to perform a wide range of language-related tasks without being explicitly programmed for each one. Examples of these tasks include text generation, translation, summarization, question answering, sentiment analysis, and natural language processing. To train a large language model, the underlying machine-learning model is provided with training data that includes examples of text to train and retrain the model to predict a next word in a sequence. Over time, the model, once trained, is configured to generate text that is coherent and contextually relevant, is configurable to mimic a style and content of the training data, and so forth. In this way, large language models provides a foundational tool in artificial intelligence for understanding and generating human language, powering a wide range of applications from conversational agents to content creation tools.

A “diffusion model” is a type of generative machine-learning model that is used for digital content creation, e.g., digital images. In order to train a diffusion model, noise is added to training data samples until the data within the training data samples is obscured. The diffusion model is then trained to reverse this process based on training data that also has a text prompt that describes the digital content to be created in order to generate data samples as the digital content that corresponds to the text prompt.

In the following discussion, an example environment is described that employs the techniques described herein. Example procedures are also described that are performable in the example environment as well as other environments. Consequently, performance of the example procedures is not limited to the example environment and the example environment is not limited to performance of the example procedures.

### Example Digital Content Generation Environment

FIG. 1 is an illustration of an environment 100 in an example implementation that is operable to employ alternative and asynchronous digital content generation techniques using machine learning as described herein. The illustrated environment 100 includes a service provider system 102 and a computing device 104 that are communicatively coupled, one to another, via a network 106. Computing devices are configurable in a variety of ways.

A computing device, for instance, is configurable as a desktop computer, a laptop computer, a mobile device (e.g., assuming a handheld configuration such as a tablet or mobile phone), and so forth. Thus, a computing device ranges from full resource devices with substantial memory and processor resources (e.g., personal computers, game consoles) to a low-resource device with limited memory and/or processing resources (e.g., mobile devices). Additionally, although a single computing device is shown and described in instances in the following discussion, a computing device is also representative of a plurality of different devices, such as multiple servers utilized by a business to perform operations “over the cloud” for the service provider system 102 and as further described in relation to FIG. 21.

The service provider system 102 includes a digital service manager module 108 that is implemented using hardware and software resources 110 (e.g., a processing device and computer-readable storage medium) in support one or more digital services 112. Digital services 112 are made available, remotely, via the network 106 to computing devices, e.g., computing device 104.

Digital services 112 are scalable through implementation by the hardware and software resources 110 and support a variety of functionalities, including accessibility, verification, real-time processing, analytics, load balancing, and so forth. Examples of digital services include a social media service, streaming service, digital content repository service, content collaboration service, and so on. Accordingly, in the illustrated example, a communication module 114 (e.g., browser, network-enabled application, and so on) is utilized by the computing device 104 to access the one or more digital services 112 via the network 106. A result of processing using the digital services 112 is then returned to the computing device 104 via the network 106.

In the illustrated example, the digital services 112 are utilized to receive an input 116 and generate digital content 118 through use of a generative artificial intelligence system, which is depicted as generative AI system 120. The generative AI system 120 is implemented using one or more machine-learning models 122, examples of which include large language models (LLMs), diffusion models, generative adversarial networks (GANs), and so on as further described below. The generative AI system 120 is configurable to generate a variety of types of digital content 118, examples of which include text, digital images, executable code, digital audio, digital video, and so forth.

As previously described, conventional techniques are confronted with numerous technical challenges that limit user interaction and result in inefficient use of computational resources. Conventional techniques, for instance, force users to manually provide independent inputs for each digital content alternative, e.g., “a red sportscar,” “a yellow sportscar,” and “a green sportscar.” Therefore, conventional techniques have an increased likelihood of user error in manually entering each alternative separately (e.g., “a read sportscar”), increased delay due to the manual entry, as well as increased computational resource consumption.

Additionally, conventional techniques are limited to synchronous execution, e.g., to process an input and wait to output a result of the processing. As a result, a user is typically forced to wait until the input is processed to then manually provide a new input, e.g., to make an edit to the input, specify an alternative, and so forth. Thus, these technical challenges reduce user efficiency, result in inefficient use of computational resources, and are frustrating.

In order to address these and other technical challenges, the generative AI system 120 employs an alternative management system 124 and an asynchronous management system 126. The alternative management system 124 is representative of functionality to automatically detect alternatives specified in a single input 116. The alternatives, once detected, are then used as a basis to generate respective prompt alternatives that are used by the one or more machine-learning models 122 as a basis to generate corresponding digital content 118. In this illustrated example, the corresponding digital content 118 and prompt alternatives are presented for concurrent display in a user interface 128 by a display device 130 of the computing device 104. In this way, user accuracy and efficiency is improved, further discussion of which may be found in relation to FIGS. 2-7 in a corresponding section.

The asynchronous management system 126 is representative of functionality that supports asynchronous user interaction as part of digital content generation using generative AI. The asynchronous management system 126, for instance, supports edits and other changes to an input 116 to then automatically and without user intervention form additional prompts that incorporate those changes. This editing functionality supports an intuitive workflow to correct mistakes, specify edits, create alternatives, and so forth, further discussion of which may be found in relation to FIGS. 8-15 and in a corresponding section

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

### Example Alternative Digital Content Generation

The following discussion describes alternative digital content generation techniques that are implementable utilizing the described systems and devices as part of generative AI. Aspects of each of the procedures are implemented in hardware, firmware, software, or a combination thereof. The procedures are shown as a set of blocks that specify operations performable by hardware and are not necessarily limited to the orders shown for performing the operations by the respective blocks. Blocks of the procedures, for instance, specify operations programmable by hardware (e.g., processor, microprocessor, controller, firmware) as instructions thereby creating a special purpose machine for carrying out an algorithm as illustrated by the flow diagram. As a result, the instructions are storable on a computer-readable storage medium that causes the hardware to perform the algorithm. FIG. 7 is a flow diagram depicting an algorithm 700 as a step-by-step procedure in an example implementation of operations performable for accomplishing a result of alternative digital content generation through formation of a plurality of prompt alternatives for alternatives detected in a single input.

FIG. 2 depicts a system 200 in an example implementation showing operation of the alternative management system 124 of the generative AI system 120 of FIG. 1 in greater detail. A single input 116 is received in this example that specifies one or more characteristics of digital content to be generated using generative artificial intelligence (AI) as implemented using one or more machine-learning models 122 (block 702). The input 116, for instance, may be configured as text, is “tokenized,” and so forth.

The alternative management system 124 then detects that the single input 116 specifies a plurality of alternatives to be used in the generation of the digital content (block 704). The alternative management system 124, for instance, employs one or more algorithms and rules to detect that the input 116 includes a disjunctive (e.g., the word “or”) and collects members of a set defined for the disjunctive within the input. The alternative management system 124, for example, receives an input 116 “make me a red, yellow, or green sportscar” and detects “red,” “yellow,” and “green” as the alternatives based on the disjunctive “or.”

In another instance, the alternative management system 124 employs one or more algorithms and rules to detect a conjunction (e.g., “and”) as listing different mutually exclusive alternatives. The alternative management system 124, for instance, detects that an input 116 specifies different members of a set having characteristics that exclusive of each other (i.e., are mutually exclusive) and thus are not includable in a single item of digital content, e.g., “make me an image and a separate sound of a barking dog.” In a further instance, the alternative management system 124 employs natural language understanding implemented by one or more machine-learning models to detect the alternatives. A variety of other instances are also contemplated.

A prompt generator module 202 is then employed by the alternative management system 124 to form a plurality of prompt alternatives. Each of the plurality of prompt alternatives correspond to a respective alternative of the plurality of alternatives (block 706) detected above. Examples of the prompt alternatives are illustrated as a first prompt alternative 204(1), . . . , through an “N” prompt alternative 204(N).

Continuing with the above sportscar example, the alternative management system 124 detects a disjunctive and corresponding alternatives of “red,” “yellow,” and “green.” The prompt generator module 202 then forms a first prompt alternative of “make me a red sportscar,” a second prompt alternative of “make me a yellow sportscar,” and a third prompt alternative of “make me a green sportscar.” In this example, each of the prompt alternatives is formed as corresponding to a respective alternative detected by the alternative management system 124 and is independent (i.e., does not include) other alternatives.

Other examples are also contemplated, however, that may include combinations of alternatives. For example, the alternative management system 124 may receive an input specifying inclusion of multiple alternatives in various combinations, e.g., “draw me a farm scene with chickens, cows, and/or sheep.”

In one or more implementations, the alternative management system 124 is also configurable to identify a respective machine-learning model from a plurality of machine-learning models to receive a respective prompt alternative (block 708). The prompt alternatives, for instance, may specify different types of digital content and therefore the alternative management system 124 identifies which of the one or more machine-learning models 122 are to be used to generate that type. In another instance, the alternative management system 124 selects the one or more machine-learning models 122 based on characteristics specified by the input 116, may be selected to optimize use of processing resources (e.g., to select a lower resource intensive option that provides comparable results), and so forth.

Once formed, the plurality of prompt alternatives are communicated by the alternative management system 124 (block 710) for processing by the one or more machine-learning models 122. The one or more machine-learning models 122, for instance, may be executed remotely by the generative AI system 120 as a digital service 112, accessed locally at a computing device that implements the generative AI system 120, and so forth. The one or more machine-learning models 122 are configurable in a variety of ways, such as diffusion models, LLMs, GANs, and so forth that are trained to generate digital content based on respective prompts.

Once the digital content is generated by the one or more machine-learning models 122 responsive to processing of the plurality of prompt alternatives, the alternative management system 124 receives the plurality of digital content (block 712). In this illustrated example, first alternative digital content 206(1) is generated responsive to a first prompt alternative 204(1), . . . , through an “N” alternative digital content 206(N) generated responsive to an “N” prompt alternative 204(N). The plurality of digital content is then presented for display in a user interface (block 714). The generative AI system 120 is configurable to support a variety of functionality as an aid to user interaction in digital content alternative generation, examples of which are further described below.

FIG. 3 depicts a system 300 in an example implementation showing reception of an input 116 to initiate digital content alternative generation. In the illustrated example, a user interface 128 is output at the computing device 104 that displays an input 116 of “Make me a beach scene with dogs, parrots, or turtles.” The input 116 is then passed to the service provider system 102 for processing. Other examples involving local processing by the computing device 104 are also contemplated.

FIG. 4 depicts a system 400 in an example implementation of prompt alternative formation by a prompt generator module 202 of the alternative management system 124 of FIG. 2 in greater detail. The prompt generator module 202, for instance, detects inclusion of a disjunctive “or” in this example and collects members of a set associated with the disjunctive (e.g., “dogs,” “parrots,” and “turtles”) as the alternatives.

The prompt generator module 202 then generates a prompt alternative for each of the detected alternatives. In this example, a first prompt alternative 204(1) specifies “make me a beach scene with dogs,” a second prompt alternative 204(2) specifies “make me a beach scene with parrots,” and a third prompt alternative 204(3) specifies “make me a beach scene with turtles.” The first, second, and third prompt alternatives 204(1), 204(2), 204(3) are then communicated by the alternative management system 124 for processing by the one or more machine-learning models 122 to generate digital content using generative AI.

FIG. 5 depicts a system 500 in an example implementation of presenting prompt alternatives and placeholders by the generative AI system 120 of the service provider system 102 for inclusion in a user interface 128 of the computing device 104. In this example, the service provider system 102 communicates the first, second, and third prompt alternatives 204(1), 204(2), 204(3) for display in the user interface 128 to indicate which prompts were generated based on the input, which is also displayed.

The generative AI system 120 also communicates a corresponding first prompt alternative placeholder 502(1), a second prompt alternative placeholder 502(2), and a third prompt alternative placeholder 502(3). The placeholders are configured to occupy and reserve space in the user interface 128 that is to be used once digital content is generated. As a result, the placeholders further act to give insight and signal to a user that processing is being performed by respective one or more machine-learning models 122.

FIG. 6 depicts a system 600 in an example implementation of presenting prompt alternatives and digital content generated by the generative AI system of FIG. 2 for respective prompt alternatives for inclusion in a user interface 128 of the computing device 104. The generative AI system 120 outputs (concurrently or in succession) first prompt digital content 206(1) corresponding to the first prompt alternative 204(1) “make me a beach scene with dogs,” second prompt digital content 206(2) corresponding to the second prompt alternative 204(2) “make me a beach scene with parrots,” and third prompt digital content 206(3) corresponding to third first prompt alternative 204(3) “make me a beach scene with turtles.”

The digital content is then displayed in the user interface 128 as replacing the placeholders as the digital content is received. In this way, the generative AI system 120 supports use of a single user input to generate a plurality of prompt alternatives to generate corresponding digital content in an efficient and intuitive manner.

### Example Asynchronous Digital Content Generation

The following discussion describes asynchronous digital content generation techniques that are implementable utilizing the described systems and devices as part of generative AI. Aspects of each of the procedures are implemented in hardware, firmware, software, or a combination thereof. The procedures are shown as a set of blocks that specify operations performable by hardware and are not necessarily limited to the orders shown for performing the operations by the respective blocks. Blocks of the procedures, for instance, specify operations programmable by hardware (e.g., processor, microprocessor, controller, firmware) as instructions thereby creating a special purpose machine for carrying out an algorithm as illustrated by the flow diagram. As a result, the instructions are storable on a computer-readable storage medium that causes the hardware to perform the algorithm. FIG. 15 is a flow diagram depicting an algorithm 1500 as a step-by-step procedure in an example implementation of operations performable for accomplishing a result of asynchronous digital content generation.

FIG. 8 depicts a system 800 in an example implementation showing operation of the asynchronous management system 126 of the generative AI system 120 of FIG. 1 in greater detail. In this example, the asynchronous management system 126 is configurable to manage asynchronous acceptance of inputs, generation of prompts based on the input, and even support editing to the inputs to automatically create new inputs. In this way, the asynchronous management system 126 supports an intuitive workflow that is not possible in conventional techniques.

In the illustrated example, a first input 116(1) is received by the asynchronous management system 126 specifying one or more digital content characteristics (block 1502). In response, a prompt generator module 202 of the asynchronous management system 126 generates a first prompt 802(1) configured to cause one or more machine-learning models to generate a first set of digital content 804(1) based on the first input 116(1) using generative artificial intelligence (AI) (block 1504). The first prompt is then presented for display in a user interface with one or more placeholders (block 1506).

FIG. 9 depicts a system 900 in an example implementation showing creation of the first input 116(1) via interaction with a user interface 128 at a computing device 104. In this example, the first input 116(1) is specified as “make me a beach scene with dogs” which is input and displayed in the user interface 128.

Entry of the first input 116(1) causes the prompt generator module 202 to generate a first prompt 802(1) which includes the text for processing by the one or more machine-learning models 122 and one or more placeholders that are communicated to the computing device 104 for display in the user interface 128. As a result, the user interface 128 provides feedback that the first input is received 116(1), what prompt is generated based on the input, and a status of processing the input through the placeholders.

In the illustrated example, an edit is made to the first prompt 802(1) by selecting the text of “dogs.” FIG. 10 depicts a system 1000 in an example implementation of showing an edit to the first prompt 802(1) of FIG. 9 via interaction with a user interface 128 at a computing device 104. A second input 116(2), for instance, is received via interaction with the first prompt 802(1) (or the first input 116(1) in another example) to change the text of “dogs” to “parrots.” In this example, the second input 116(2) is received prior to receipt of a first set of digital content 804(1) by the computing device 104 as generated using generative artificial intelligence (AI) responsive to the first prompt 802(1) (block 1508). Other examples are also contemplated, in which the edit is received during processing of the first set of digital content 804(1) by the generative AI system 120.

In response, the edit is communicated back to the generative AI system 120. The generative AI system 120 then generates a second prompt 802(2) configured to cause the one or more machine-learning models 122 to generate a second set of digital content 804(2) based on the second input (block 1510). FIG. 11 depicts a system 1100 in an example implementation of showing presentation of prompts that are generated based on the edit to the first prompt 802(1) of FIG. 10 via interaction with a user interface 128 at a computing device 104.

As depicted, the edit to the first prompt 802(1) causes output of a second prompt 802(2) in the user interface 128. Additionally, text of the first prompt 802(1) is returned to its original form (e.g., make me a beach scene with dogs”) as being processed by the one or more machine-learning models 122 of the generative AI system 120.

The first set of digital content and the second set of digital content are then presented for display in a user interface (block 1512) as generated by the one or more machine-learning models 122 using the generative AI system 120. This process may continue for additional edits thereby supporting an intuitive workflow.

FIG. 12 depicts an example implementation 1200 of an edit to text of a second prompt 802(2) of FIG. 11. In this example, the edit is made by selecting and replacing the word “parrots” with “turtles” in the second prompt 802(2) via the user interface 128. During this edit, the first set of digital content 804(1) corresponding to the first prompt 802(1) is received and displayed in the user interface 128 as replacing respective placeholders, thereby support asynchronous entry of the second input.

FIG. 13 depicts an example implementation 1300 showing presentation of prompts that are generated based on the edit to the second prompt 802(2) of FIG. 12 via interaction with a user interface 128 at a computing device 104. As before, the edit to the second prompt 802(2) causes automatic generation and presentation of a third prompt 802(3), with the second prompt 802(2) being returned to its unedited form. In an implementation, generation of the second prompt may also cause output of an option that is user selectable to cease processing of the first prompt.

In the illustrated example, the second set of digital content 802(2) corresponding to the second prompt 802(2) is also received and presented in the user interface 128 with placeholders being displayed as associated with the third prompt 802(3). FIG. 14 depicts an example implementation 1400 showing presentation of the first set of digital content 804(1) as associated with the first prompt 802(1), the second set of digital content 804(2) as associated with the second prompt 802(2), and the third set of digital content 804(4) as associated with the third prompt. In this way, the asynchronous management system 126 supports asynchronous digital content generation, which is not possible in conventional techniques.

FIG. 16 shows an example of a guided diffusion model 1600 according to aspects of the present disclosure. In some examples, guided diffusion model 1600 is an example of the one or more machine-learning models 122 of FIG. 1. Diffusion models are a class of generative neural networks which can be trained to generate new data with features similar to features found in training data. In particular, diffusion models can be used to generate novel media items such as images, audio files, videos, three-dimensional (3D) models or other digital media items. Diffusion models can be used for various media processing tasks including image super-resolution, generation of media items with perceptual metrics, conditional generation (e.g., generation based on text guidance), image inpainting, and media manipulation.

Diffusion models work by iteratively adding noise to the data during a forward process and then learning to recover the data by denoising the data during a reverse process. For example, during training, guided latent diffusion model 1600 may take an original media item 1605 in a pixel space 1610 as input and apply forward diffusion process 1615 to gradually add noise to the original media item 1605 to obtain noisy media item 1620 at various noise levels.

Next, a reverse diffusion process 1625 (e.g., a U-Net) gradually removes the noise from the noisy media item 1620 at the various noise levels to obtain an output media item 1630. In some cases, an output media item 1630 is created from each of the various noise levels. The output media item 1630 can be compared to the original media item 1605 to train the reverse diffusion process 1625.

The reverse diffusion process 1625 can also be guided based on a text prompt 1635, or another guidance prompt, such as an image, a layout, a segmentation map, etc. The text prompt 1635 can be encoded using a text encoder 1640 (e.g., a multimodal encoder) to obtain guidance features 1645 in guidance space 1650. The guidance features 1645 can be combined with the noisy media item 1620 at one or more layers of the reverse diffusion process 1625 to ensure that the output media item 1630 includes content described by the text prompt 1635. For example, guidance features 1645 can be combined with the noisy features using a cross-attention block within the reverse diffusion process 1625.

Methods of operating diffusion models include a Denoising Diffusion Probabilistic Model (DDPM) and a Denoising Diffusion Implicit Models (DDIM). In DDPM, the generative process includes reversing a stochastic Markov diffusion process. DDIMs, on the other hand, use a deterministic process so that the same input results in the same output. In some cases, DDIM can reduce the number of timesteps during media generation. Diffusion models may also be characterized by whether the noise is added to the media item itself, or to media features generated by an encoder (i.e., latent diffusion). In a pixel diffusion model, noise is added and removed in pixel space. In a latent diffusion model, the noise is added (and removed) in a latent space of media features rather than in pixel space. Thus, a latent diffusion model generates media features using reverse diffusion, and these media features can be decoded to obtain a synthetic media item.

FIG. 17 shows an example of a technique 1700 for conditional media generation according to aspects of the present disclosure. In some examples, technique 1700 describes an operation of the one or more machine-learning models 122 of FIG. 1. In some examples, these operations are performed by a system including a processor executing a set of codes to control functional elements of an apparatus.

Additionally or alternatively, steps of the technique 1700 may be performed using special-purpose hardware. Generally, these operations are performed according to the methods and processes described in accordance with aspects of the present disclosure. In some cases, the operations described herein are composed of various substeps, or are performed in conjunction with other operations.

At operation 1705, a user provides a text prompt describing content to be included in a generated media item. For example, a user may provide the prompt “a person playing with a cat”. In some examples, guidance can be provided in a form other than text, such as via an image, a sketch, or a layout.

At operation 1710, the system converts the text prompt (or other guidance) into a conditional guidance vector or other multi-dimensional representation. For example, text may be converted into a vector or a series of vectors using a transformer model, or a multi-modal encoder. In some cases, the encoder for the conditional guidance is trained independently of the diffusion model.

At operation 1715, a noise map is initialized that includes random noise. The noise map may be in a pixel space or a latent space. By initializing a media item with random noise, different variations of a media item including the content described by the conditional guidance can be generated.

At operation 1720, the system generates a media item based on the noise map and the conditional guidance vector. For example, the media item may be generated using a reverse diffusion process.

FIG. 18 shows a diffusion process 1800 according to aspects of the present disclosure. In some examples, diffusion process 1800 describes an operation of the digital content 118.

Use of a diffusion model can involve both a forward diffusion process 1805 for adding noise to a media item (or features in a latent space) and a reverse diffusion process 1810 for denoising the media item (or features) to obtain a denoised media item. The forward diffusion process 1805 can be represented as q(xₜ|xₜ₋₁), and the reverse diffusion process 1810 can be represented as p(xₜ₋₁|xₜ). In some cases, the forward diffusion process 1805 is used during training to generate media items with successively greater noise, and a neural network is trained to perform the reverse diffusion process 1810 (i.e., to successively remove the noise).

In an example forward process for a latent diffusion model, the model maps an observed variable x₀ (either in a pixel space or a latent space) intermediate variables x₁, . . . , x_{T} using a Markov chain. The Markov chain gradually adds Gaussian noise to the data to obtain the approximate posterior q(x_{1:T}|x₀) as the latent variables are passed through a neural network such as a U-Net, where x₁, . . . , x_{T} have the same dimensionality as x₀.

The neural network may be trained to perform the reverse process. During the reverse diffusion process 1810, the model begins with noisy data x_{T}, such as a noisy media item 1815 and denoises the data to obtain the p(xₜ₋₁|xₜ). At each step t−1, the reverse diffusion process 1810 takes xₜ, such as first intermediate media item 1820, and t as input. Here, t represents a step in the sequence of transitions associated with different noise levels, The reverse diffusion process 1810 outputs xₜ₋₁, such as second intermediate media item 1825 iteratively until x_{T} reverts back to x₀, the original media item 1830. The reverse process can be represented as:

$${p}_{θ} ( {x}_{t - 1} \vert {x}_{t} ) := N ( {x}_{t - 1} ; {μ}_{θ} ( {x}_{t} , t ) , {\sum }_{θ} ( {x}_{t} , t ) ) .$$

The joint probability of a sequence of samples in the Markov chain can be written as a product of conditionals and the marginal probability:

$${x}_{T} : {p}_{θ} ( {x}_{0 : T} ) := p ( {x}_{T} ) {\prod }_{t = 1}^{T} {p}_{θ} ( {x}_{t - 1} \vert {x}_{t} )$$

where p(x_{T})=N(x_{T};0,I) is the pure noise distribution as the reverse process takes the outcome of the forward process, a sample of pure noise, as input and

$${\prod }_{t = 1}^{T} {p}_{θ} ( {x}_{t - 1} \vert {x}_{t} )$$

represents a sequence of Gaussian transitions corresponding to a sequence of addition of Gaussian noise to the sample.

At interference time, observed data x₀ in a pixel space can be mapped into a latent space as input and a generated data \tilde{x} is mapped back into the pixel space from the latent space as output. In some examples, x₀ represents an original input media item with low quality, latent variables x₁, . . . , x_{T} represent noisy media items, and \tilde{x} represents the generated item with high quality.

FIG. 19 is a flow diagram depicting an algorithm as a step-by-step procedure 1900 in an example implementation of operations performable for training a machine-learning model. In some embodiments, the procedure 1900 describes an operation of a training component for the one or more machine-learning models 122. The procedure 1900 provides one or more examples of generating training data, use of the training data to train a machine-learning model, and use of the trained machine-learning model to perform a task.

To begin in this example, a machine-learning system collects training data (block 1902) that is to be used as a basis to train a machine-learning model, i.e., which defines what is being modeled. The training data is collectable by the machine-learning system from a variety of sources. Examples of training data sources include public datasets, service provider system platforms that expose application programming interfaces (e.g., social media platforms), user data collection systems (e.g., digital surveys and online crowdsourcing systems), and so forth. Training data collection may also include data augmentation and synthetic data generation techniques to expand and diversify available training data, balancing techniques to balance a number of positive and negative examples, and so forth.

The machine-learning system is also configurable to identify features that are relevant (block 1904) to a type of task, for which the machine-learning model is to be trained. Task examples include classification, natural language processing, generative artificial intelligence, recommendation engines, reinforcement learning, clustering, and so forth. To do so, the machine-learning system collects the training data based on the identified features and/or filters the training data based on the identified features after collection. The training data is then utilized to train a machine-learning model.

In order to train the machine-learning model in the illustrated example, the machine-learning model is first initialized (block 1906). Initialization of the machine-learning model includes selecting a model architecture (block 1908) to be trained. Examples of model architectures include neural networks, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, etc.

A loss function is also selected (block 1910). The loss function is utilized to measure a difference between an output of the machine-learning model (i.e., predictions) and target values (e.g., as expressed by the training data) to be used to train the machine-learning model. Additionally, an optimization algorithm is selected (1912) that is to be used in conjunction with the loss function to optimize parameters of the machine-learning model during training, examples of which include gradient descent, stochastic gradient descent (SGD), and so forth.

Initialization of the machine-learning model further includes setting initial values of the machine-learning model (block 1916) examples of which includes initializing weights and biases of nodes to improve efficiency in training and computational resources consumption as part of training. Hyperparameters (block 1914) are also set that are used to control training of the machine learning model, examples of which include regularization parameters, model parameters (e.g., a number of layers in a neural network), learning rate, batch sizes selected from the training data, and so on. The hyperparameters are set using a variety of techniques, including use of a randomization technique, through use of heuristics learned from other training scenarios, and so forth.

The machine-learning model is then trained using the training data (block 1918) by the machine-learning system. A machine-learning model refers to a computer representation that can be tuned (e.g., trained and retrained) based on inputs of the training data to approximate unknown functions. In particular, the term machine-learning model can include a model that utilizes algorithms (e.g., using the model architectures described above) to learn from, and make predictions on, known data by analyzing training data to learn and relearn to generate outputs that reflect patterns and attributes expressed by the training data.

Examples of training types include supervised learning that employs labeled data, unsupervised learning that involves finding an underlying structures or patterns within the training data, reinforcement learning based on optimization functions (e.g., rewards and/or penalties), use of nodes as part of “deep learning,” and so forth. The machine-learning model, for instance, is configurable as including a plurality of nodes that collectively form a plurality of layers. The layers, for instance, are configurable to include an input layer, an output layer, and one or more hidden layers. Calculations are performed by the nodes within the layers through the hidden states through a system of weighted connections that are “learned” during training, e.g., through use of the selected loss function and backpropagation to optimize performance of the machine-learning model to perform an associated task.

As part of training the machine-learning model, a determination is made as to whether a stopping criterion is met (decision block 1920), i.e., which is used to validate the machine-learning model. The stopping criterion is usable to reduce overfitting of the machine-learning model, reduce computational resource consumption, and promote an ability of the machine-learning model to address previously unseen data, i.e., that is not included specifically as an example in the training data. Examples of a stopping criterion include but are not limited to a predefined number of epochs, validation loss stabilization, achievement of a performance improvement threshold, whether a threshold level of accuracy has been met, or based on performance metrics such as precision and recall. If the stopping criterion has not been met (“no” from decision block 1920), the procedure 1900 continues training of the machine-learning model using the training data (block 1918) in this example.

If the stopping criterion is met (“yes” from decision block 1920), the trained machine-learning model is then utilized to generate an output based on subsequent data (block 1922). The trained machine-learning model, for instance, is trained to perform a task as described above and therefore once trained is configured to perform that task based on subsequent data received as an input and processed by the machine-learning model.

FIG. 20 shows an example of a technique 2000 for training a diffusion model according to aspects of the present disclosure. In some implementations, the technique 2000 describes an operation of a training component for configuring the one or more machine-learning models 122. In some examples, these operations are performed by a system including a processor executing a set of codes to control functional elements of an apparatus.

Additionally or alternatively, certain processes of technique 2000 may be performed using special-purpose hardware. Generally, these operations are performed according to the methods and processes described in accordance with aspects of the present disclosure. In some cases, the operations described herein are composed of various substeps, or are performed in conjunction with other operations.

At operation 2005, the user initializes an untrained model. Initialization can include defining the architecture of the model and establishing initial values for the model parameters. In some cases, the initialization can include defining hyperparameters such as the number of layers, the resolution and channels of each layer blocks, the location of skip connections, and the like.

At operation 2010, the system adds noise to a media item using a forward diffusion process in N stages. In some cases, the forward diffusion process is a fixed process where Gaussian noise is successively added to media item. In latent diffusion models, the Gaussian noise may be successively added to features in a latent space.

At operation 2015, the system at each stage n, starting with stage N, a reverse diffusion process is used to predict the output or features at stage n−1. For example, the reverse diffusion process can predict the noise that was added by the forward diffusion process, and the predicted noise can be removed from the noise input to obtain the predicted output. In some cases, an original media item is predicted at each stage of the training process.

At operation 2020, the system compares predicted output (or features) at stage n−1 to an actual media item (or features), such as the output at stage n−1 or the original input. For example, given observed data x, the diffusion model may be trained to minimize the variational upper bound of the negative log-likelihood −log p_{θ}(x) of the training data.

At operation 2025, the system updates parameters of the model based on the comparison. For example, parameters of a U-Net may be updated using gradient descent. Time-dependent parameters of the Gaussian transitions can also be learned.

### Example System and Device

FIG. 21 illustrates an example system generally at 2100 that includes an example computing device 2102 that is representative of one or more computing systems and/or devices that implement the various techniques described herein. This is illustrated through inclusion of the generative AI system 120. The computing device 2102 is configurable, for example, as a server of a service provider, a device associated with a client (e.g., a client device), an on-chip system, and/or any other suitable computing device or computing system.

The example computing device 2102 as illustrated includes a processing device 2104, one or more computer-readable media 2106, and one or more I/O interface 2108 that are communicatively coupled, one to another. Although not shown, the computing device 2102 further includes a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing device 2104 is representative of functionality to perform one or more operations using hardware. Accordingly, the processing device 2104 is illustrated as including hardware element 2110 that is configurable as processors, functional blocks, and so forth. This includes implementation in hardware as an application specific integrated circuit or other logic device formed using one or more semiconductors. The hardware elements 2110 are not limited by the materials from which they are formed or the processing mechanisms employed therein. For example, processors are configurable as semiconductor(s) and/or transistors (e.g., electronic integrated circuits (ICs)). In such a context, processor-executable instructions are electronically-executable instructions.

The computer-readable storage media 2106 is illustrated as including memory/storage 2112 that stores instructions that are executable to cause the processing device 2104 to perform operations. The computer-readable storage medium is configured for storing instructions that, responsive to execution by the processing device, causes the processing device to perform operations. The memory/storage 2112 represents memory/storage capacity associated with one or more computer-readable media. The memory/storage 2112 includes volatile media (such as random access memory (RAM)) and/or nonvolatile media (such as read only memory (ROM), Flash memory, optical disks, magnetic disks, and so forth). The memory/storage 2112 includes fixed media (e.g., RAM, ROM, a fixed hard drive, and so on) as well as removable media (e.g., Flash memory, a removable hard drive, an optical disc, and so forth). The computer-readable media 2106 is configurable in a variety of other ways as further described below.

Input/output interface(s) 2108 are representative of functionality to allow a user to enter commands and information to computing device 2102, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., employing visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 2102 is configurable in a variety of ways as further described below to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are configurable on a variety of commercial computing platforms having a variety of processors.

An implementation of the described modules and techniques is stored on or transmitted across some form of computer-readable media. The computer-readable media includes a variety of media that is accessed by the computing device 2102. By way of example, and not limitation, computer-readable media includes “computer-readable storage media” and “computer-readable signal media.”

“Computer-readable storage media” refers to media and/or devices that enable persistent and/or non-transitory storage of information (e.g., instructions are stored thereon that are executable by a processing device) in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media include but are not limited to RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and are accessible by a computer.

“Computer-readable signal media” refers to a signal-bearing medium that is configured to transmit instructions to the hardware of the computing device 2102, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 2110 and computer-readable media 2106 are representative of modules, programmable device logic and/or fixed device logic implemented in a hardware form that are employed in some embodiments to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing are also be employed to implement various techniques described herein. Accordingly, software, hardware, or executable modules are implemented as one or more instructions and/or logic embodied on some form of computer-readable storage media and/or by one or more hardware elements 2110. The computing device 2102 is configured to implement particular instructions and/or functions corresponding to the software and/or hardware modules. Accordingly, implementation of a module that is executable by the computing device 2102 as software is achieved at least partially in hardware, e.g., through use of computer-readable storage media and/or hardware elements 2110 of the processing device 2104. The instructions and/or functions are executable/operable by one or more articles of manufacture (for example, one or more computing devices 2102 and/or processing devices 2104) to implement techniques, modules, and examples described herein.

The techniques described herein are supported by various configurations of the computing device 2102 and are not limited to the specific examples of the techniques described herein. This functionality is also implementable all or in part through use of a distributed system, such as over a “cloud” 2114 via a platform 2116 as described below.

The cloud 2114 includes and/or is representative of a platform 2116 for resources 2118. The platform 2116 abstracts underlying functionality of hardware (e.g., servers) and software resources of the cloud 2114. The resources 2118 include applications and/or data that can be utilized while computer processing is executed on servers that are remote from the computing device 2102. Resources 2118 can also include services provided over the Internet and/or through a subscriber network, such as a cellular or Wi-Fi network.

The platform 2116 abstracts resources and functions to connect the computing device 2102 with other computing devices. The platform 2116 also serves to abstract scaling of resources to provide a corresponding level of scale to encountered demand for the resources 2118 that are implemented via the platform 2116. Accordingly, in an interconnected device embodiment, implementation of functionality described herein is distributable throughout the system 2100. For example, the functionality is implementable in part on the computing device 2102 as well as via the platform 2116 that abstracts the functionality of the cloud 2114.

In implementations, the platform 2116 employs a “machine-learning model” that is configured to implement the techniques described herein. A machine-learning model refers to a computer representation that can be tuned (e.g., trained and retrained) based on inputs to approximate unknown functions. In particular, the term machine-learning model can include a model that utilizes algorithms to learn from, and make predictions on, known data by analyzing training data to learn and relearn to generate outputs that reflect patterns and attributes of the training data. Examples of machine-learning models include neural networks, convolutional neural networks (CNNs), long short-term memory (LSTM) neural networks, decision trees, and so forth.

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method comprising:
receiving, by a processing device, a single input specifying one or more characteristics of digital content to be generated using generative artificial intelligence (AI) as implemented using one or more machine-learning models;
detecting, by the processing device, that the single input specifies a plurality of alternatives to be used in the generation of the digital content;
forming, by the processing device, a plurality of prompt alternatives, each said prompt alternative corresponding to a respective alternative of the plurality of alternatives;
receiving, by the processing device, a plurality of digital content generated by the one or more machine-learning models using the generative artificial intelligence responsive to processing of the plurality of prompt alternatives; and
presenting, by the processing device, the plurality of digital content for display in a user interface.

2. The method as described in claim 1, wherein the detecting is performed by detecting text in the single input as indicating the plurality of alternatives.

3. The method as described in claim 1, wherein the detecting is performed using natural language understanding implemented by the one or more machine-learning models.

4. The method as described in claim 1, wherein a first said prompt alternative includes a first said alternative and a second said prompt alternative includes a second said alternative, the first said prompt alternative being independent of inclusion of the second said alternative and the second said prompt alternative being independent of inclusion of the first said prompt alternative.

5. The method as described in claim 1, wherein the presenting includes presenting the plurality of prompt alternatives for display in the user interface as associated with respective items of the plurality of digital content generated for respective said prompt alternatives.

6. The method as described in claim 5, wherein the presenting includes initially presenting the plurality of prompt alternatives for display in the user interface along with respective placeholders and then replacing the respective placeholders with the respective items of the plurality of digital content.

7. The method as described in claim 1, further comprising identifying a respective said machine-learning model from a plurality of said machine-learning models to receive a respective said prompt alternative and communicating the respective said prompt alternative to the respective said machine-learning model.

8. The method as described in claim 7, wherein a first said prompt alternative is communicated to a first said machine-learning model and a second said prompt alternative is communicated to a second said machine-learning model that is different than the first said machine-learning model.

9. The method as described in claim 8, wherein the receiving includes receiving a first said digital content from the first said machine-learning model having a digital content type that is different from a second said digital content that is received from the second said machine-learning model.

10. A computing device comprising:
a processing device; and
a computer-readable storage medium storing instructions that, responsive to execution by the processing device, causes the processing device to perform operations including:
receiving a first input specifying one or more digital content characteristics;
generating a first prompt configured to cause one or more machine-learning models to generate a first set of digital content based on the first input using generative artificial intelligence (AI);
receiving a second input specifying an edit to the first prompt, the second input received prior to receipt of a first set of digital content generated using generative artificial intelligence (AI) responsive to the first prompt;
generating a second prompt configured to cause the one or more machine-learning models to generate a second set of digital content based on the second input; and
presenting the first set of digital content and the second set of digital content for display in a user interface.

11. The computing device as described in claim 10, wherein the second input is received during processing of the first prompt by the one or more machine-learning models.

12. The computing device as described in claim 10, further comprising presenting the first prompt for display in the user interface responsive to the generating of the first prompt.

13. The computing device as described in claim 12, wherein the receiving of the edit to the first input is performed via the user interface by editing text of the first prompt.

14. The computing device as described in claim 13, further comprising presenting the second prompt for display in the user interface along with the first prompt responsive to the generating of the second prompt responsive to the receiving of the edit.

15. The computing device as described in claim 10, wherein the presenting includes presenting the first prompt in conjunction with the first set of digital content and the second prompt in conjunction with the second set of digital content.

16. The computing device as described in claim 10, wherein the presenting includes initially presenting the first prompt for display in the user interface along with one or more respective placeholders and then replacing the one or more respective placeholders with the first set of digital content.

17. The computing device as described in claim 16, wherein the initially presenting is performed during the receiving of the second input.

18. One or more computer-readable storage media storing instructions that, responsive to execution by a processing device, causes the processing device to perform operations comprising:
detecting a single input as specifying a plurality of alternatives to be used in digital content generation;
forming a plurality of prompt alternatives, each said prompt alternative corresponding to a respective alternative of the plurality of alternatives;
communicating the plurality of prompt alternatives for processing by one or more machine-learning models using generative artificial intelligence; and
receiving a plurality of digital content generated responsive to processing of the plurality of prompt alternatives, respectively, by the one or more machine-learning models.

19. The one or more computer-readable storage media as described in claim 18, further comprising identifying a respective said machine-learning model from a plurality of said machine-learning models to receive a respective said prompt alternative and the communicating includes communicating the respective said prompt alternative to the respective said machine-learning model.

20. The one or more computer-readable storage media as described in claim 18, wherein the detecting is performed by detecting text in the single input indicating the plurality of alternatives using natural language understanding implemented by the one or more machine-learning models.
